(19) United States
(12) Patent Application Publication
(10) Pub. No.: US 2014/0304135 A1
(43) Pub. Date: Oct. 9, 2014

(54) APPARATUS, SYSTEM AND METHOD FOR PROVIDING A CITY-CENTRIC EXCHANGE TRADED FUND

(71) Applicant: LocalShares, LLC, Nashville, TN (US)

(72) Inventors: William Decker, Nashville, TN (US); Elizabeth Courtney, Nashville, TN (US)

(21) Appl. No.: 14/197,012

(22) Filed: Mar. 4, 2014

Related U.S. Application Data
(60) Provisional application No. 61/772,416, filed on Mar. 4, 2013.

(51) Int. Cl. G06Q 40/04

(52) U.S. Cl. CPC G06Q 40/04
USPC 705/37

(57) ABSTRACT

The present invention may provide exchange traded funds (ETFS) focused on the investment potential of cities as demonstrated by their headquartered companies within targeted geographic markets. The present invention may account for a city's economy functions as its own ecosystem with unique resources, attributes and demographics inextricably interwoven. Such city-based ETFS may fulfill a distinguishable and highly marketable niche by providing acceleratable and/or scalable products which may be intuitively appealing and understandable to a significant number of investors, both institutional and individual.

### CROSS-REFERENCE TO RELATED APPLICATIONS

This application claims priority to U.S. Provisional Application No. 61/772,416, filed Mar. 4, 2013, titled AN APPARATUS, SYSTEM AND METHOD FOR PROVIDING A CITY-CENTRIC EXCHANGE TRADED FUND, the entirety of which is incorporated herein by reference as if set forth in its entirety.

### FIELD OF THE INVENTION

The present invention relates to the creation of financial vehicles and, more particularly, to the provision of a city-centric exchange traded fund.

### BACKGROUND OF THE INVENTION

There is a growing need for exchange traded fund (ETF) companies to focus on the investment potential of cities as demonstrated by their headquartered companies. The premise of such an investment concept is that every city's economy functions as its own ecosystem with unique resources, attributes and demographics inextricably interwoven. The publicly traded companies concentrated around a city enable investors to reap the benefits of a vibrant region.

### SUMMARY OF THE INVENTION

The present invention may provide exchange traded funds (ETFS) focused on the investment potential of cities as demonstrated by their headquartered companies within targeted geographic markets. The present invention may account for a city's economy functions as its own ecosystem with unique resources, attributes and demographics inextricably interwoven. Such city-based ETFS may fulfill a distinguishable and highly marketable niche by providing acceleratable and/or scalable products which may be intuitively appealing and understandable to a significant number of investors, both institutional and individual.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods; and

FIG. 3 illustrates an exemplary embodiment in accordance with the herein described systems and methods;

FIG. 4 illustrates an exemplary embodiment in accordance with the herein described systems and methods;

FIG. 5 illustrates an exemplary embodiment in accordance with the herein described systems and methods;

FIG. 6 illustrates an exemplary embodiment in accordance with the herein described systems and methods; and

FIG. 7 illustrates an exemplary embodiment in accordance with the herein described systems and methods.

### DETAILED DESCRIPTION

A computer-implemented platform and methods of use are disclosed that provide networked access to a plurality of types of digital content and information. It is to be understood that the figures and descriptions of the present invention have been simplified to illustrate elements that are relevant for a clear understanding of the present invention, while eliminating, for the purpose of clarity, many other elements found in typical financial, securities, and securities trading apparatuses, systems, and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to the disclosed elements and methods known to those skilled in the art.

Moreover, the instant disclosure is made with reference to calculations and the obtaining of information. It will be appreciated that these calculations are performed by software code stored in one or more computing memories, and at the indication of one or more computing processors. Further, such calculations may occur by a single local or remote processor, or by at least two distributed processors. Accordingly, the instant invention is preferably interconnected to one or more telecommunications networks, such as the Internet. Thereby, the information discussed herein, such as city-centric statistical information, may be obtained via communication directed by the one or more processors with one or more remote computer storage locations, such as one or more databases, which may be accessible by the one or more processors using one or more telecommunications links, such as one or more html, ftp, telnet, or like links.

Yet further, although the disclosure herein may be made by way of definitive terminology, such as “is,” “does”, “flows”, “indicates,” or the like, those skilled in the art will appreciate, in view of the discussion herein, that the disclosure is made by way of example.

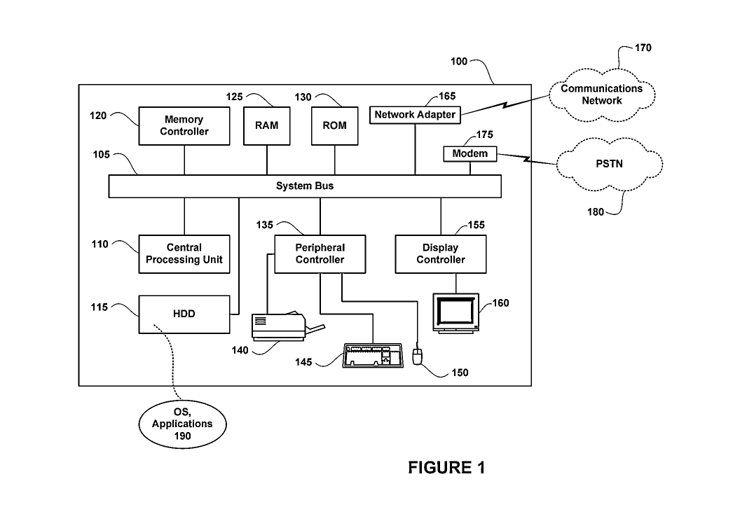

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

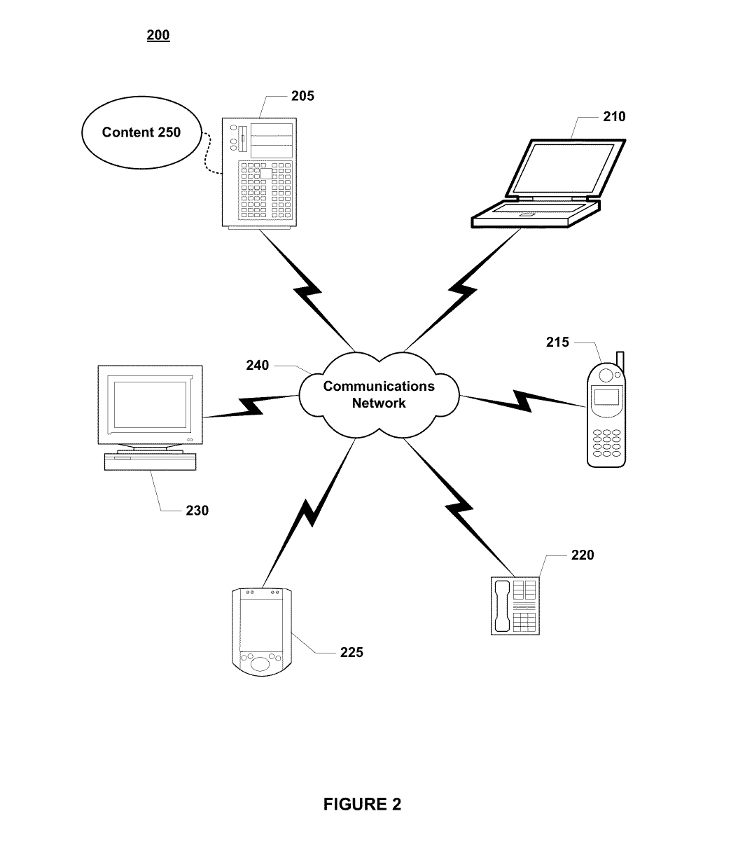

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

The techniques described herein may be used for various wireless communication networks, such as CDMA, TDMA, FDMA, OFDMA, SC FDMA, and other wireless networks. The terms “network” and “system” are often used interchangeably herein. By way of example, a CDMA network may implement a radio technology such as Universal Terrestrial Radio Access (UTRA), cdma2000, and the like. For example, an OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, and the like. UTRA and E-UTRA are part of Universal Mobile Telecommunication System (UMTS). UTRA, E-UTRA, UMTS, as well as long term evolution (LTE) and other cellular techniques, are described in documents from an organization named “3rd Generation Partnership Project” (3GPP) and “3rd Generation Partnership Project 2” (3G PP2).

“WiFi” stands for “Wireless Fidelity.” WiFi is typically deployed as a wireless local area network (WLAN) that may extend home and business networks to wireless medium. As referenced, the IEEE 802,11 standard defines WiFi communications as between devices, and as between devices and access points. WiFi typically provides aggregate user data speeds from 2 Mbps (for 802.11b) to approximately 150 Mbps (for 802.11n). Typical speeds for WiFi are around 15 Mbps, and latency (i.e., packet delay) averages around 10 ms with no load. WiFi may link devices, and/or devices and access points, over distances from a few feet to several miles. By way of contrast, LTE, as mentioned above, typically provides WAN connectivity that may stretch for much greater distances, but is typically not preferred for LAN communications. Of note, the techniques described herein may be used for the wireless networks and radio technologies mentioned above, as well as for other wireless networks and radio technologies.

WiFi networks, herein also referred to as IEEE 802.11 wireless networks, may operate in two modes: infrastructure mode and ad-hoc mode. In infrastructure mode, a device connects to an access point (AP) that serves as a hub for connecting wireless devices to the network infrastructure, including, for example, connecting wireless devices to Internet access. Infrastructure mode thus uses a client-server architecture to provide connectivity to the other wireless devices. In contrast to the client-server architecture of infrastructure mode, in ad-hoc mode wireless devices have direct connections to each other in a peer-to-peer architecture.

### Exemplary Embodiment

### Nashville ETF

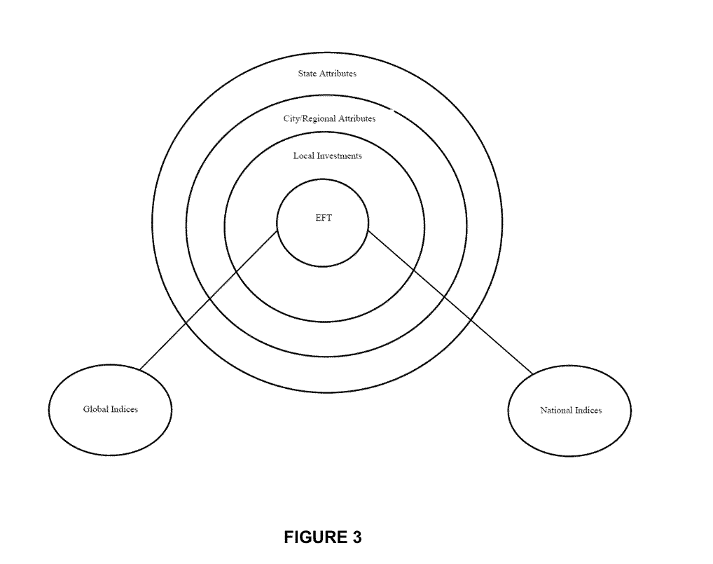

Referring now to FIG. 3, an ETF created by the present invention may be unique to at least one city-specific (or greater metropolitan) region. Factors that may be taken into account include, for example, population size; per capita income; corporate taxation; favorability of court systems toward corporations; number of local universities; number of publicly traded companies; diversity of publicly traded companies; city marketing sophistication (such as may be indicated by city economic indicators); city geography; city topology; city utilities, roads, and the like; city population diversity; number and success of college or professional sports teams; etc., may contribute to the selection of a particular region/city as the basis for an ETF. In an exemplary embodiment, 4 or more of the foregoing factors may be selected, and/or 4 or more of the foregoing factors may be independently weighted, to indicate creation of one of more city-based ETFS.

Although much of the discussion herein will be made with reference to the “Nashville” exemplary embodiment, those skilled in the pertinent arts will appreciate that the invention is equally applicable to a great many cities. As such, the discussion herein of a Nashville ETF is intended to be non-limiting.

For example, a EFT created by the present invention may include a Nashville-based ETF regionally-based and comprised of stocks of well-performing publicly-traded companies based in middle Tennessee. Such a “Nashville ETF” may harnesses civic pride and community spirit to generate consistent and significant returns for investors. The created Nashville ETF may also provide economic and marketing drivers for the Nashville region and may provide a capital source for companies wishing to establish themselves in and/or about the Nashville region. The Nashville EFT may allow facilitate direct local investment in Nashville, such as by city-based entities, such as pension funds for Nashville city employees, for example.

The present invention may factor in city/regional attributes when forming an EFT and may, for example, consider any existing framework for corporate recruiting and participation that will lead to rapid acceptance and promotion of the fund; the base of well-performing headquartered companies in the region; the local economy (including, for example, statistics from specific market forces, such as, for example, the healthcare sector); and the long-term expectations for population growth.

For example, a Nashville focused EFT may consider such attributes as the Nashville area GDP of $79 billion in 2008 (up 16% in only four years) and that between 2008 and 2009, 102 companies expanded or relocated to middle Tennessee, creating 7396 new jobs across myriad industries such as healthcare, publishing and manufacturing.

Factoring in such information in a regionally focused manner has led to unexpected results. More specifically, the exemplary Nashville EFT has, since it was established in August 2010, out-performed the S&P, the 2000 and blended indexes of each. In fact, the portfolio has produced a since-inception return of 31.5%; compared with a segment-blended analysis of 17.0%.

The present invention may rely on a predetermined group of attributes for selected individual stocks selections with a chosen region. By way of non-limiting example only, Nashville area stocks may be selected measuring criteria which may include: a market capitalization of greater than $100 million; an average trading volume greater than $100 million; and a share price greater than $5, for example. The automation of the selection process may allow for fees to be charge well below those understood in the art to be necessary for developing and sustaining a fund. For example, the resent invention may allow for a management fee of about 0.49 basis points as compared to a current industry low of about 9.0 basis points.

Purchasers and investors of such an EFT may include: institutional investors, including the managers of pension funds of major institutions and governmental bodies; managers of the pension funds and 401 Ks of companies held by the fund; managers of funds of locally-based foundations; and individuals who have community confidence and loyalty.

### The Market for Investing Locally

A driving force behind the success of an EFT provided by the present invention is that a city-based ETF is simple: people are loyal to the cities they know and are emotionally invested in their success. City-based ETFS enable individuals to convert that emotional attachment into a financial investment that creates returns for investors while enabling them to support the economies of their local communities. Studies show that individuals love their hometowns and see them as superior to others. The same qualities that lead people to passionately support local sports teams, restaurants and companies have never before been channeled through a fund product. Especially during the current economic climate, there is an emphasis on buying locally. From foods to products, Americans are increasingly committed to supporting their own communities. The unique concept of city-based ETFs taps into these same loyalties. People have a natural tendency to invest in companies based on where they currently or previously worked or lived. It's in part because they come to know well the businesses that thrive and the individuals who lead them.

As will be appreciated by this skilled in the art, four factors may be needed for ETF creation: an index to track; liquid and marketable underlying securities that make up the ETF; successful passage of the idea through SEC registration; and market participants. The present invention takes advantage of the ETF marketplace allowing for an investment vehicle that enables the establishment of funds that are generally less expensive and more targeted.

### Exemplary Method Embodiment

Certain local markets may be especially conducive to economic success, and therefore to investment performance of publicly traded companies headquartered in these local markets. Once a region is chosen, the decision to invest in companies from a specific area, the follow-on decisions include: selection of specific companies in which to invest, allocation of the original investment among those selected companies, and management of those investments over time.

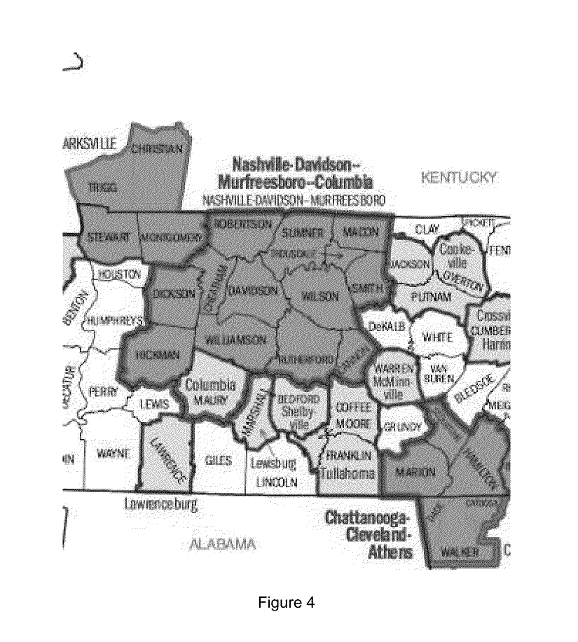

As illustrated in FIG. 4, the present invention may identify a specific geographic area in which companies of interested may be headquartered (which may be defined as the corporate street address in their most recent annual SEC filing). Information to identify such an area may also come from a review of definitions and maps from the Office of Management and Budget (OMB) regarding standard Metropolitan and Micropolitan Statistical Areas (MMSA)s, for example. In the case of the Nashville Index discussed herein, this area would be described by the OMB as the “Nashville-Davidson-Murfreesboro-Franklin, Tenn. Metropolitan Statistical Area”. Per the OMB, this MMSA includes the following counties: Cannon, Cheatham, Davidson, Dickson, Hickman, Macon, Robertson, Rutherford, Smith, Sumner, Trousdale, Williamson, and Wilson. The present invention may deem the economic value of the area to be too small or restrictive, with reference to at least one predefined value, and may consider other groupings defined by the OMB, including Combined Statistical Areas (CSA)s and Component Core Based Statistical Areas (CCBSA)s which in some cases may be required in order to include enough companies to meet exchange listing requirements or may better match public perception of the described area. In the case of the Nashville Index, this would add the “Columbia, Tenn. Micropolitan Statistical Area” to the MMSA noted above, and would be referred to by the OMB as the “Nashville-Davidson-Murfreesboro-Columbia, Tenn. Combined Statistical Area”.

If a group exceeds a predefined value, smaller groupings may be used to establish an index, one which may be based on a cartographic review with an emphasis on what area is generally understood by the public to be defined by the name of the Index.

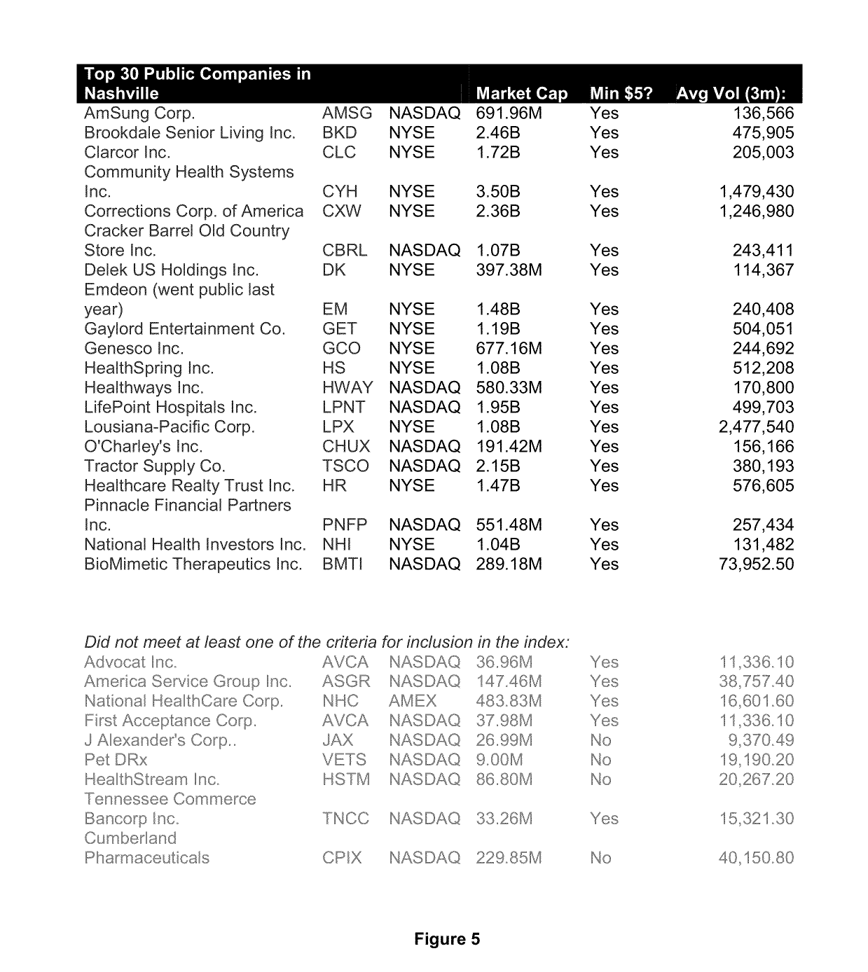

As referenced above, company selection may be performed in accordance with the exemplary embodiment of FIG. 5. For example, the present invention may begin with a list of all publicly-traded companies headquartered in the subject area. Although any number of information sources may be used, an exemplary source may be the MarketSmith database, for example. Companies not meeting specific location criteria may be dropped from consideration for inclusion in the index.

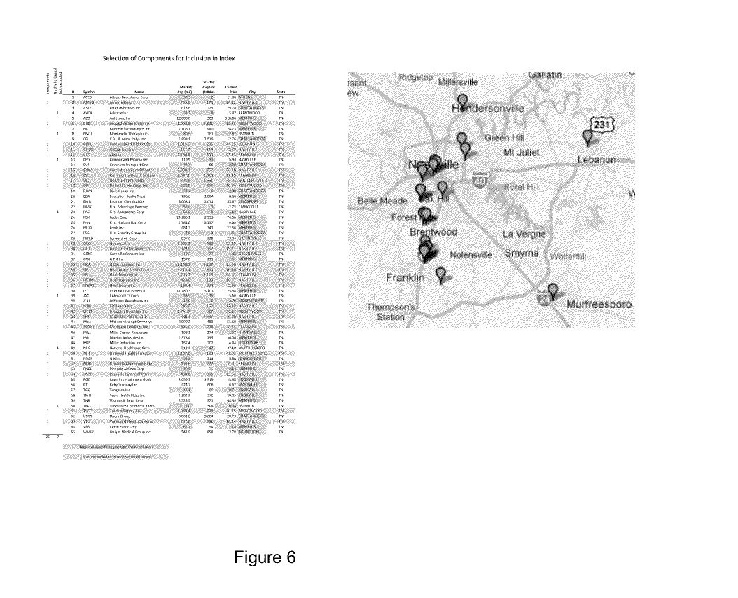

To maintain adequate liquidity and meet listing requirements from the NYSE, the present invention may further refine the list to include only companies which meet the following requirements: market capitalization of at least $100 million; average volume for past 50 days of at least 50,000 per day; and current share price of at least $5.00. As illustrated in FIG. 6, every company passing the four filters (location, capitalization, volume, and price) may be included in the index. Mapping may also be used to geo-locate the target investments. In this way, for example, otherwise qualifying companies falling outside a predetermined range from the center of a particular area may be excluded (such as those qualifying companies greater than 30 miles from downtown Nashville).

Once a plurality of companies have been identified by the present invention, the allocation of investment may begin which may include at least three basic strategic directions with regard to the weighting of the index, namely: capitalization-based; equally weighted; and fundamental or other metrics. A straight capitalization-based weighting structure may, in many cases, result in an index completely dominated by one or two of its components which would not be representative of the region, creating an index which would not be of much use, adding little value to an investor who could instead just buy those one or two positions and receive substantially similar returns as provided by the index.

An equally-weighted index carries some of the same issues regarding simplicity and lack of added value (vs. individual portfolios) but also introduces the substantial risk of allocating a significant portion of the index to an extremely small and possibly poorly-performing fund—even to the point where liquidity could become a legitimate issue of concern for fund shareholders.

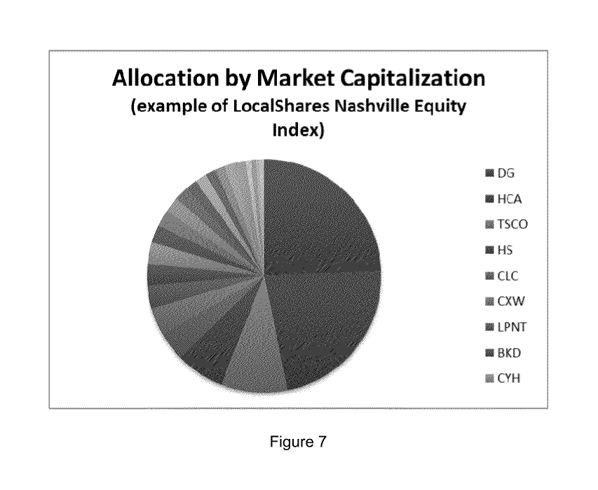

Due to the shortcomings of the two aforementioned strategies, as well as the belief that it is a better approach on its own merits, the present invention may employ an “intelligent index” based on certain publicly available factors (such as growth of earnings, change in share price, growth of sales, etc) that has the potential of adding value to shareholders by increased allocations to equities likely to provide better performance, while still maintaining the benefits of a passive structure. The result of such methodology is expressed in the illustration provided by FIG. 7 and may be limited to at least the following factors (each company meeting the inclusion criteria has been held in the portfolio. At the beginning of the calculation, each position is equally weighted.):

Factor 1a may be calculated for well over 1,000 publicly traded companies, and uses widely-available and known datapoints relating to earnings growth and surprises, price changes, and trends in both earnings and prices. The impact of this factor on a position may range from a coefficient of −0.75 to +1.50.

Factor 1b is used only when Factor 1a cannot be calculated due to lack of available data. It is similar in nature to Factor 1b but available for a wider universe of positions due to some data required for Factor 1a but not available. The impact of this factor on a position may range from a coefficient of −0.45 to +1.25. In very rare cases where neither Factor 1a nor 1b may be calculated, the position will advance in the calculation with a coefficient of 1.00. The use of these two factors intentionally introduces a slight bias toward larger-cap companies, which offsets a bias toward smaller-cap companies stemming from the inclusion of a large number of companies with an initially equal weight.

Factor 2 is related to recent earnings, and its impact will generally be less significant than Factors 1a & 1b. Its range is determined by relative scoring to the other companies in the index. Outliers on the distribution of this factor have ranged from coefficients of −0.69 to +1.34.

Factor 3 takes several sub-factors into account, including data related to sales, profit margins, and return on equity. As with Factor 2, its range is determined by relative scoring, and has ranged from coefficients of −0.06 to +1.07.

No single position has been allowed to represent more than twice what its allocation would have been under an equally-weighted portfolio. If steps 1-5 resulted in a figure that exceeded this limit, the allocation was capped.

We anticipate limiting each position to a level where LocalShares does not trigger burdensome SEC reporting requirements. As the prototype account began with just $50,000, we're still quite a ways from having to worry about owning more than 5% of any of the companies.

An ETF created by the present invention may be associated may issue Creation Units in kind in exchange for a basket of stocks that consist of securities that are included in a fund's index. The index may be established to gauge the successfulness of an ETF. It may be comprised of publicly traded companies that have their corporate headquarters or principal place of business in a particular region or that generate significant portion of their revenues in the region.

All companies that meet inclusion requirements may not necessarily be included in an index. Parameters contained in the present invention may allow for a rules-based decision process. The system may also redeem Creation Units in kind; for example, for an investor who tenders a Creation Unit may receive, as redemption proceeds, a basket of stocks that are part of the portfolio holdings (an in-kind redemption basket). Such an in-kind Creation Basket and the In-Kind Redemption Basket may usually, but may not always, be the same. As part of any creation or redemption transaction, a user of the system may either pay or receive some cash in addition to the securities, as described more fully below. Fund shares may be redeemed with the Fund in large lots of 50,000 shares known as “Creation Units.”

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A computer-implemented engine for generating an exchange traded fund comprising a plurality of shares, over a network, responsively to input fund information, comprising:
a first graphical user interface capable of locally querying at least one financial information source for compiling company specific results comprising at least general company information, company financial information, company presence information;
a rules engine for comparing the company specific results against the input fund information; and
a second graphical user interface capable of offering the plurality of shares for sale and effectuating the selling of one or more of the shares to one or more appropriate buyers.

2. The computer-implemented engine of claim 1 in which the step of selling comprises selling the shares at any time intraday.

3. The computer-implemented engine of claim 1 in which the exchange traded fund further comprises a plurality of share classes.

4. The computer-implemented engine of claim 3 in which the step of selling further comprise selling a plurality of shares specific to one or more of the share classes.

5. The computer-implemented engine of claim 1, wherein the input fund information comprises location information.
